(19) United States
(12) Patent Application Publication
(10) Pub. No.: US 2002/0087612 A1
(43) Pub. Date: Jul. 4, 2002

(54) System and method for reliability-based load balancing and dispatching using software rejuvenation

(76) Inventors: Richard Edwin Harper, Chapel Hill, NC (US); Steven Wade Hunter, Raleigh, NC (US); Gregg Matthew Margosian, Raleigh, NC (US)

Correspondence Address: Andrew J. Dillon, FELSMAN, BRADLEY, VADEN, GUNTER & DILLON, LLP, Lakewood on the Park, Suite 350, 7600B North Capital of Texas Highway, Austin, TX, 78731, US

(21) Appl. No.: 09/752,840

(22) Filed: Dec. 28, 2000

(51) Int. Cl. G06F 9/00

(52) U.S. Cl. 709/100; 714/47

(57) ABSTRACT

A method of operating a node of a computer network which uses a plurality of servers, by determining that one of the servers has degraded health due to software aging, assigning tasks to the other servers while reducing workload at the first server, rejuvenating the first server once its workload has terminated and, after rejuvenation, assigning tasks to the first server. The servers are clustered to provide service based on a single server address (TCP/IP). The node may include a gateway interface which receives the server requests and passes them on to a dispatcher at the node. Tasks are assigned in response to health-related messages sent by the servers and received by a workload monitor agent of the dispatcher.

### CROSS-REFERENCE TO RELATED APPLICATION

This application is related to U.S. patent application Ser. No. ______ (Attorney docket number RPS9-20000073US1) filed concurrently herewith and entitled “System and Method for Performing Automatic Rejuvenation in a Server Cluster.”

### BACKROUND OF THE INVENTION

1. Field of the Invention

The present invention generally relates to computer systems, particularly to a method of enhancing the reliability and performance of a distributed processing system, and more specifically to a system and method for improving a load-balancing mechanism in a computer network.

2. Description of Related Art

A generalized client-server computing network 2 is shown in FIG. 1. Network 2 has several nodes or servers 4, 6, 8 and 10 which are interconnected, either directly to each other or indirectly through one of the other servers. Each server is essentially a stand-alone computer system (having one or more processors, memory devices, and communications devices), but has been adapted (programmed) for one primary purpose, that of providing information to individual users at another set of nodes, or workstation clients 12. A client is a member of a class or group of computers or computer systems that uses the services of another class or group to which it is not related. Clients 12 can also be stand-alone computer systems (like personal computers, or PCs), or “dumber” systems adapted for limited use with network 2 (like network computers, or NCs). A single, physical computer can act as both a server and a client, although this implementation occurs infrequently.

The information provided by a server can be in the form of programs which run locally on a given client 12, or in the form of data such as files that are used by other programs. Users can also communicate with each other in real-time as well as by delayed file delivery, i.e., users connected to the same server can all communicate with each other without the need for the network 2, and users at different servers, such as servers 4 and 6, can communicate with each other via network 2. The network can be local in nature, or can be further connected to other systems (not shown) as indicated with servers 8 and 10.

The construction of network 2 is also generally applicable to the Internet. In the context of a computer network such as the Internet, a client is a process (i.e., a program or task) that requests a service which is provided by another program. The client process uses the requested service without having to “know” any working details about the other program or the service itself. Based upon requests by the user, a server presents filtered electronic information to the user as server responses to the client process.

Conventional protocols and services have been established for the Internet which allow the transfer of various types of information, including electronic mail, simple file transfers via FTP (file transfer protocol), remote computing via Telnet, “gopher” searching, Usenet newsgroups, and hypertext file delivery and multimedia streaming via the World Wide Web (WWW). A given server can be dedicated to performing one of these operations, or running multiple services. Internet services are typically accessed by specifying a unique address, or universal resource locator (URL). The URL has two basic components, the protocol to be used, and the object pathname. For example, the URL “http://www.uspto.gov” (home page for the United States Patent & Trademark Office) specifies a hypertext transfer protocol (“http”) and a pathname of the server (“www.uspto.gov”). The server name is associated with a unique numeric value (a TCP/IP address, or “domain”).

Network computing allows for distributed processing, wherein one or more tasks may be broken up into separate processing threads that can be individually assigned to different network nodes for completion. In the context of the Internet, one example of distributed processing is the ability to use multiple servers to act as a single node or TCP (transfer control protocol) address. In a typical IP (internet protocol) network dispatching environment, a network dispatching (ND) function dynamically monitors and balances TCP servers and application workload in real time. Lightly loaded servers are preferentially given workloads over heavily loaded servers, in an attempt to keep all servers equally loaded, and prevent any servers from becoming overloaded. From the point of view of the dispatching component, the aggregate of servers appears as a single logical entity. The main advantages of load balancing are that it allows heavily accessed Web sites to increase capacity, since multiple TCP servers can be dynamically added while retaining the abstraction of a single entity that appears in the network as a single logical server, and allows workloads to be steered away from failed TCP servers in order for them to be serviced.

One problem that affects both user workstations and network servers is a “software aging” behavior, wherein the data processing system's failure rate increases over time, typically because of programming errors that generate increasing and unbounded resource consumption, or due to data corruption and numerical error accumulation (e.g., round-off errors). Examples of the effects of such errors are memory leaks, file systems that fill up over time, and spawned threads or processes that are never terminated. Software aging may be caused by errors in a program application, operating system software, or “middleware” (software adapted to provide an interface between applications and an operating system). As the allocation of a system's resources gradually approaches a critical level, the probability that the system will suffer an outage increases. This may be viewed as an increase in the software system's failure rate. Such a software system failure may result in overall system failure, crashing, hanging, performance degradation, etc.

One way of reducing software failure rate is to reset a portion of the system to recover any lost and unused resources. For example, this may be accomplished by resetting just the application that is responsible for the aging, or by resetting the entire computer system. This type of maintenance is referred to as software rejuvenation; see, e.g., U.S. Pat. No. 5,715,386. When the part of the system that is undergoing aging is reinitialized via rejuvenation, its failure rate falls back to its initial (i.e., lower), level because resources have been freed up and/or the effects of numerical errors have been removed. This has a dramatic effect on overall system availability. However, when the failure rate begins to climb again due to the above-mentioned causes, subsequent rejuvenations become necessary.

When the health of a network server suffers from software aging, it is difficult to correct the problem without adversely affecting its performance. In current systems, workload can be steered away from a faulty server by the ND, but only after the server has catastrophically failed. Sudden failure of a server and the subsequent recovery results in a large temporary surge in session reconnection attempts, network traffic, dispatcher CPU utilization and, in some cases, client reconnections. Such disruptive behavior is highly undesirable in this environment. It would, therefore, be beneficial to devise a method of reducing or eliminating unplanned or partial system outages in a network which might otherwise be caused by effects such as software aging. It would be further advantageous if the method could be implemented transparently to a user of the system.

SUMMARY OF THE INVENTION

It is therefore one object of the present invention to provide an improved computer network.

It is another object of the present invention to provide such an improved computer network utilizing a load balancing scheme to spread work tasks across multiple nodes of the network.

It is yet another object of the present invention to substantially reduce or eliminate performance degradation due to unplanned failures in multiple server systems which are associated with software aging.

The foregoing objects are achieved in a method of operating a node of a computer network, wherein the node includes a plurality of servers, the method generally comprising the steps of determining that a first one of the servers has degraded health due to software aging, assigning tasks to one or more of the servers other than the first server, while reducing workload at the first server, rejuvenating the first server once its workload has terminated in response to said assigning step and, after said rejuvenating, assigning tasks to the first server. The servers are clustered to provide service based on a single server address (TCP/IP). This may include a gateway interface for presenting the single address which receives the server requests and forwards them to the dispatching component. The requests are distributed to the servers based on the performance and health-related information received from the servers. The determination is made by evaluating performance of the first server using an application performance and health monitor, and generating a health-related message indicating that the first server requires rejuvenation. Rejuvenating is accomplished by reinitializing one or more of a server application, server middleware, or server operating system on the first server.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 is a diagram of a conventional computer network, including interconnected servers and client workstations;

FIG. 2 is a block diagram illustrating one embodiment of a multi-server network node constructed in accordance with the present invention; and

FIG. 3 is a chart illustrating the logic flow according to one implementation of the present invention.

### DESCRIPTION OF AN ILLUSTRATIVE EMBODIMENT

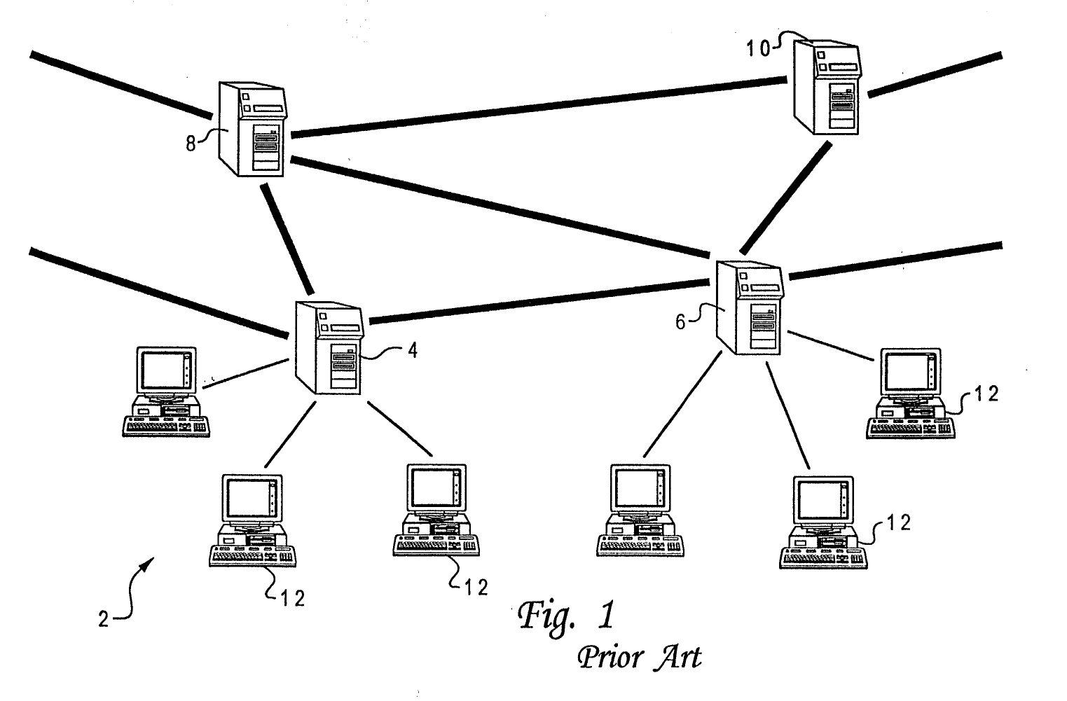

The present invention is directed to a method of enhancing the performance and reliability of a distributed processing system, particularly a system that is part of a computer network such as a local area network (LAN) or the Internet, similar to that depicted in FIG. 1. The invention may, however, be implemented in other networks so, while the present invention may be understood with reference to FIG. 1, this reference should not be construed in a limiting sense.

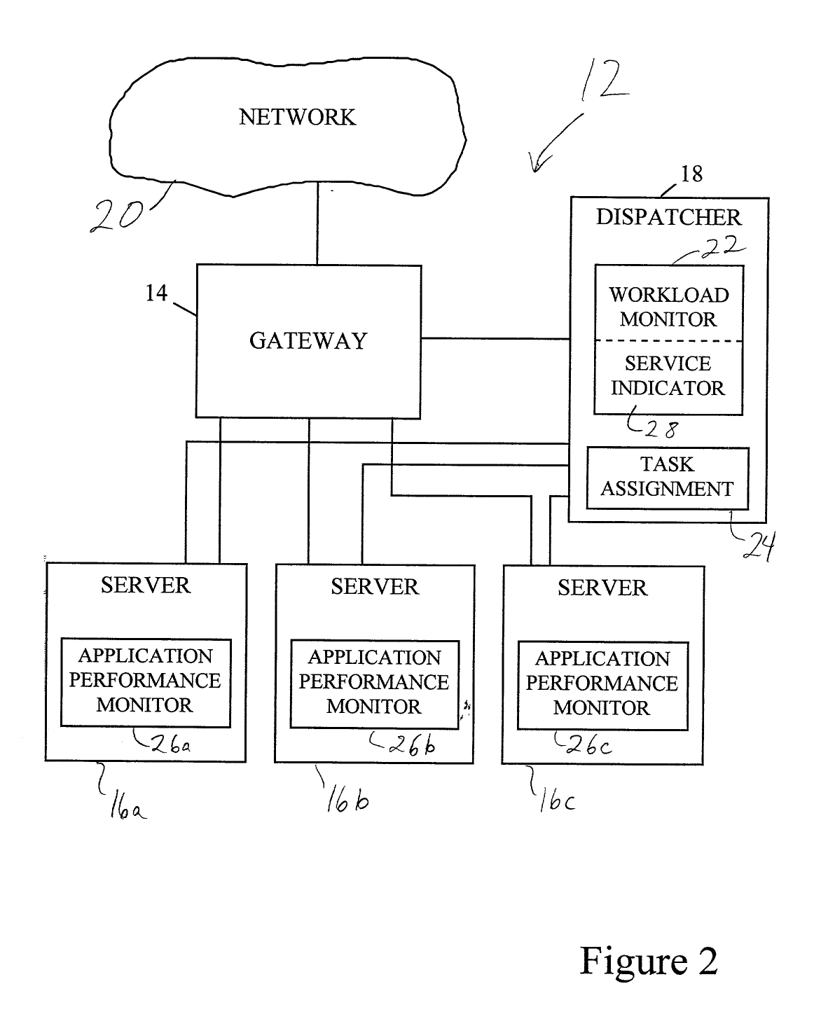

With further reference to FIG. 2, there is depicted one embodiment 12 of a multi-server network node constructed in accordance with the present invention. Node 12 is adapted to act as a single network location, e.g., a single TCP address. In an exemplary implementation, node 12 is an internet server, and may provide web pages in hypertext transfer protocol, or provide other electronic information using other conventional protocols.

Node 12 is generally comprised of a gateway interface 14, a plurality of servers 16a, 16b and 16c, and a task dispatcher 18. While three servers are shown, those skilled in the art will appreciate that a smaller or larger number of servers may be utilized in variations of the present invention. Gateway 14 uses a conventional interface to communicate with the remainder of the network 20, i.e., other gateways, routers or bridges which provide connectivity with end users at client workstations. While gateway 14 and dispatcher 16 are shown as separate logical entities, they may be implemented on a single data processing system. This data processing system may be a conventional, general-purpose computer programmed according to the teachings herein, and provided with one or more network interface devices such as an ethernet card. This same data processing system may also act as one of the servers.

Dispatcher 18 acts to spread out the workload among the servers 14a, 14b and 14c. Dispatcher 18 includes a workload monitor 22 which receives performance and health-related messages from each of the servers. As with the prior art, dispatcher 18 uses this information to balance the overall workload across all of the servers. Dispatcher 18 receives client requests via gateway 14, and task assignment logic 24 assigns the next task to the server with the lightest current workload, to avoid any given server from becoming overloaded.

Each server has an application performance and health monitor 26a, 26b, and 26c. The application performance and health monitors are processes running on each server which use conventional techniques to evaluate server performance and health based on the current usage of various system resources. Application performance and health monitors 26a, 26b, and 26c construct a performance and health-related message to inform dispatcher 18 how busy and healthy the particular server is.

Application performance and health monitors 26a, 26b, and 26c additionally provide the novel function of informing dispatcher 18 whenever a server requires software rejuvenation. Rejuvenation services may be indicated by observing various signs of software aging including, but not limited to, excess memory usage or overflows, software exceptions, livelocks, deadlocks, etc. This invention improves the overall system availability of a web by applying the software failure prediction technology to the existing framework in which a Network Dispatching (ND) component is used. Currently, the TCP servers used in this configuration send performance related information (via messages) to the ND so that Load Balancing can be accomplished. This invention extends this concept, so that the TCP servers will also send health-related information to the ND. In one implementation, instead of providing an indication of how busy the server is, a health-related message indicates that the server needs to go offline completely. This message is recognized by service indicator logic 28, and dispatcher 18 then begins transitioning workload off of this server and onto other active and operational servers. In an alternative implementation, the service (health-related) message can be appended to the performance-related message, to inform the ND of the current workload as well.

In the depicted embodiment, service indicator logic 28 is integrated into workload monitor 22. The workload will dwindle to zero as new workload is steered to other servers and old requests on the aging server are completed. When all the workload has been removed, the selective rejuvenation process can begin; the server can be taken offline with little or no disruption in the overall service of node 12.

The server may be rejuvenated in a conventional manner by, e.g., re-initializing the server application, middleware, or operating system. Once rejuvenation has been completed, the rejuvenated server can rejoin the server group by notifying dispatcher 18 (via workload monitor 22) that it is available, and begin accepting workload again. The present invention thus helps to eliminate unplanned partial system outages by predicting an imminent failure, taking the appropriate steps to move user sessions to an alternative operational and healthy server, proactively servicing the unhealthy server via software rejuvenation, and returning it to active service. This procedure improves the overall system availability to the end user, eliminates disruptive unplanned outages and transparently transitions them to a more reliable operating environment.

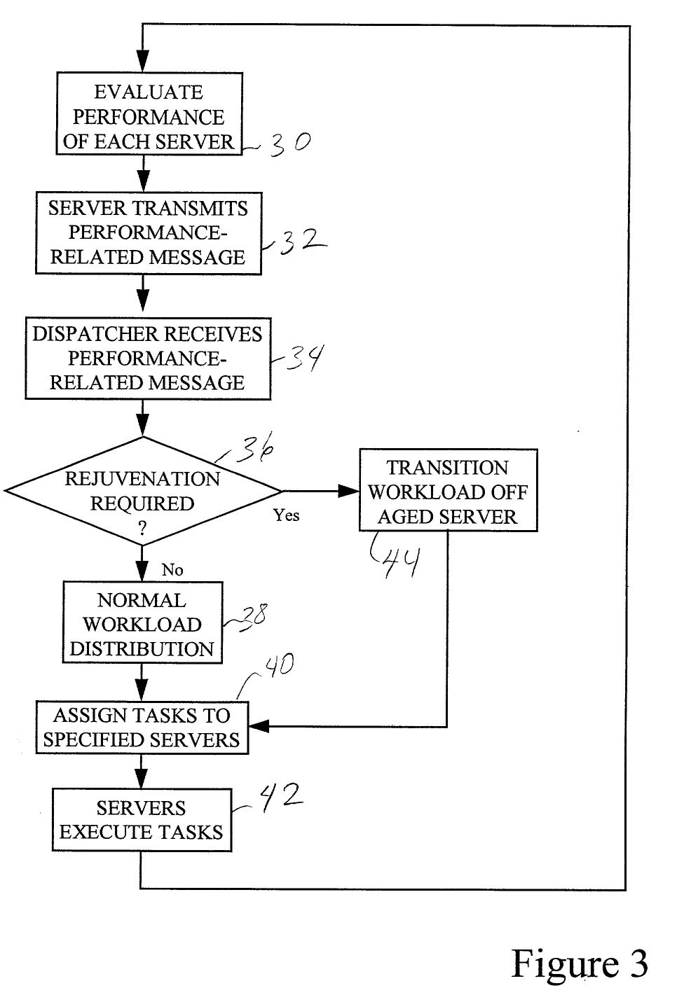

This implementation of the present invention may further be understood with reference to the flow chart of FIG. 3. The process begins with each server evaluating its current performance (30). The servers then transmit performance-related and/or health related messages to the dispatcher (32). The messages are received by the dispatcher and processed by the workload monitor/service indicator (34), and a determination is made as to whether any of the servers requires rejuvenation (36). If not, the task assignment logic at the dispatcher uses its normal workload distribution routine (38), and assigns various tasks to the specified servers (40). The servers process those tasks (42), and the process repeats in an iterative fashion.

If the determination step 36 indicates that rejuvenation is required, then the task assignment logic instead begins to transition the workload away from the aged server (44). Tasks are again assigned (40), although now in a manner which will eliminate new tasks being assigned to the aged server. When activity has ceased, the aged server can be taken offline. After rejuvenation has been completed, the aged server can rejoin the group by notifying the dispatcher.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. For example, while the illustrative embodiment has been described in the context of a client-server network, those skilled in the art will appreciate that it can be practiced in a peer-to-peer network as well. In addition, this technique is applicable to other computing environments where load-based dispatching to an aggregate of servers is used; examples include transaction processing, file serving, application serving, messaging, mail serving, and many others. It is therefore contemplated that such modifications can be made without departing from the spirit or scope of the present invention as defined in the appended claims.

1. A method of operating a node of a computer network, wherein the node includes a plurality of servers, the method comprising the steps of:
determining that a first one of the servers has degraded health due to software aging;
assigning tasks to one or more of the servers other than the first server, while reducing workload at the first server;
rejuvenating the first server once its workload has terminated in response to said assigning step; and
after said rejuvenating step, assigning tasks to the first server.

2. The method of claim 1 wherein said determining step is performed in response to the step of each server independently evaluating its performance.

3. The method of claim 1 wherein said assigning steps are performed in response to server requests submitted to the node as a single server address.

4. The method of claim 3 further comprising the steps of a gateway interface at the node receiving the server requests and passing the requests to a dispatcher at the node.

5. The method of claim 4 wherein said assigning steps are performed in response to health-related messages sent by the servers and received by a workload monitor agent of the dispatcher.

6. The method of claim 5 wherein said determining step is performed in response to the steps of:
evaluating performance of the first server using an application performance monitor; and
generating a health-related message from the first server indicating that the first server requires rejuvenation.

7. The method of claim 1 wherein said rejuvenating step includes the step of re-initializing one or more of a server application, server middleware, or server operating system.

8. A computer network node comprising:
a plurality of servers;
means for determining that a first one of the servers has degraded health due to software aging;
means for assigning tasks to one or more of the servers other than said first server, while reducing workload at said first server, responsive to said determining means; and
means for rejuvenating said first server once its workload has terminated in response to said assigning means, wherein said assigning means resumes assigning tasks to said first server after said first server has been rejuvenated.

9. The computer network node of claim 8 further comprising means for independently evaluating each servers' performance.

10. The computer network node of claim 8 wherein said assigning means is responsive to server requests submitted to the node as a single server address.

11. The computer network node of claim 10 wherein said assigning means includes a dispatcher, and a gateway interface for receiving the server requests and passing the requests to said dispatcher.

12. The computer network node of claim 11 wherein said assigning means is responsive to health-related messages sent by said servers and received by a workload monitor agent of said dispatcher.

13. The computer network node of claim 8 wherein said determining means includes:
an application performance monitor which evaluates performance of said first server; and
means for generating a health-related message from said first server indicating that said first server requires rejuvenation.

14. The computer network node of claim 8 wherein said rejuvenating means includes means for re-initializing one or more of a server application, server middleware, or server operating system.

15. A computer program product for operating a network node having a plurality of servers, comprising:
a computer-readable storage medium; and
program instructions stored on said storage medium for (i) determining that a first one of the servers has degraded health due to software aging, (ii) assigning tasks to one or more of the servers other than the first server, while reducing workload at the first server, responsive to said determining, (iii) rejuvenating the first server once its workload has terminated in response to said assigning, and (iv) assigning tasks to the first server after the first server has been rejuvenated.

16. The computer program product of claim 15 wherein said program instructions are further for independently evaluating each servers' performance.

17. The computer program product of claim 15 wherein said program instructions further assign the tasks responsive to server requests submitted to the node as a single server address.

18. The computer program product of claim 17 wherein said program instructions further pass the server requests from a gateway interface at the node to a dispatcher at the node.

19. The computer program product of claim 18 wherein said program instructions further assign the tasks responsive to health-related messages sent by the servers and received by a workload monitor agent of the dispatcher.

20. The computer program product of claim 19 wherein said program instructions further generate a health-related message for the first server indicating that the first server requires rejuvenation.

21. The computer program product of claim 15 wherein said program instructions further rejuvenate the first server by re-initializing one or more of a server application, server middleware, or server operating system.
